(19) United States
(12) Patent Application Publication
(10) Pub. No.: US 2025/0155725 A1
(43) Pub. Date: May 15, 2025

(54) OPTICAL MEMBER DRIVING MECHANISM

(71) Applicant: TDK TAIWAN CORP., Taoyuan City (TW)

(72) Inventors: Po-Xiang ZHUANG, Taoyuan City (TW); Jui-Ta CHIEN, Taoyuan City (TW); Wei-Jhe SHEN, Taoyuan City (TW); Sin-Jhong SONG, Taoyuan City (TW); Ko-Lun CHAO, Taoyuan City (TW); Shou-Jen LIU, Taoyuan City (TW); Kun-Shih LIN, Taoyuan City (TW)

(21) Appl. No.: 18/940,341

(22) Filed: Nov. 7, 2024

Related U.S. Application Data
(60) Provisional application No. 63/597,919, filed on Nov. 10, 2023.

(51) Int. Cl. G02B 27/64

(52) U.S. Cl. CPC G02B 27/646

(57) ABSTRACT

An optical member driving mechanism is provided. The optical member driving mechanism includes a movable portion, a fixed portion, and a driving assembly. The movable portion is configured to connect an optical member, and is movable relative to the fixed portion. The driving assembly is configured to drive the movable portion to move.

### CROSS REFERENCE TO RELATED APPLICATIONS

This application claims the benefit of U.S. Provisional Application No. 63/597,919, filed Nov. 10, 2023, the entirety of which is incorporated by reference herein.

### BACKGROUND OF THE INVENTION

### Field of the Invention

The application relates in general to an optical member driving mechanism, and in particular it relates to an optical member driving mechanism for driving an optical member to move.

### Description of the Related Art

As technology has advanced, a lot of electronic devices (for example, tablet computers and smartphones) have been equipped with the functionality of taking photographs and recording video. These electronic devices have become more commonplace, and have been developed to be more convenient and thin. More and more choices are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

In some embodiments, the optical member driving mechanism can further include a supporting assembly, and the movable portion moves relative to the fixed portion through the supporting assembly. The supporting assembly includes a first intermediate member, a first corresponding member, a first forcing member, and a first stabilizing member. The first corresponding member is in contact with the first intermediate member, and the first intermediate member and the first corresponding member are movable relative to each other. A first stabilizing force is applied to the movable portion by the first forcing member and the first stabilizing member. When viewed along the main axis, the fixed portion has a polygonal structure, and the first intermediate member is disposed on the first side of the fixed portion. When viewed along the main axis, the first intermediate member is adjacent to the first corner of the fixed portion, and the distance between the first stabilizing member and the first corner is less than the distance between the first intermediate member and the first corner.

### BRIEF DESCRIPTION OF DRAWINGS

The invention can be more fully understood by reading the subsequent detailed description and examples with references made to the accompanying drawings, wherein:

FIG. 1 is a schematic diagram of an electronic device having an optical member driving mechanism according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4 is a cross-sectional view taken along the line A-A in FIG. 2;

FIG. 5A is a schematic diagram of the movable portion, the first coil, and the second coil according to an embodiment of the invention;

FIG. 5B is a schematic diagram of the movable portion, the first coil, the second coil, the first intermediate member, the first forcing member, and the reference member according to an embodiment of the invention;

FIG. 6 is a cross-sectional view taken along the line B-B in FIG. 2;

FIG. 7 is a top view of the optical member driving mechanism according to an embodiment of the invention, wherein the housing is omitted; and

FIG. 8 is a schematic diagram of an optical member driving mechanism according to another embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

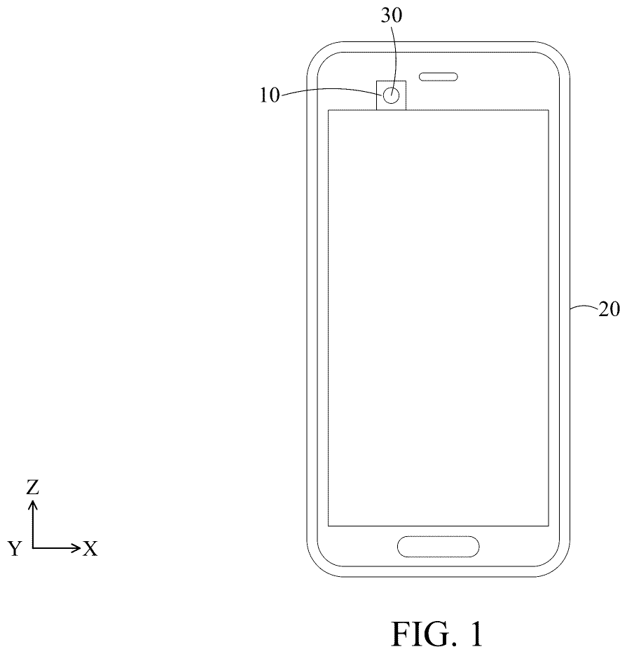

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

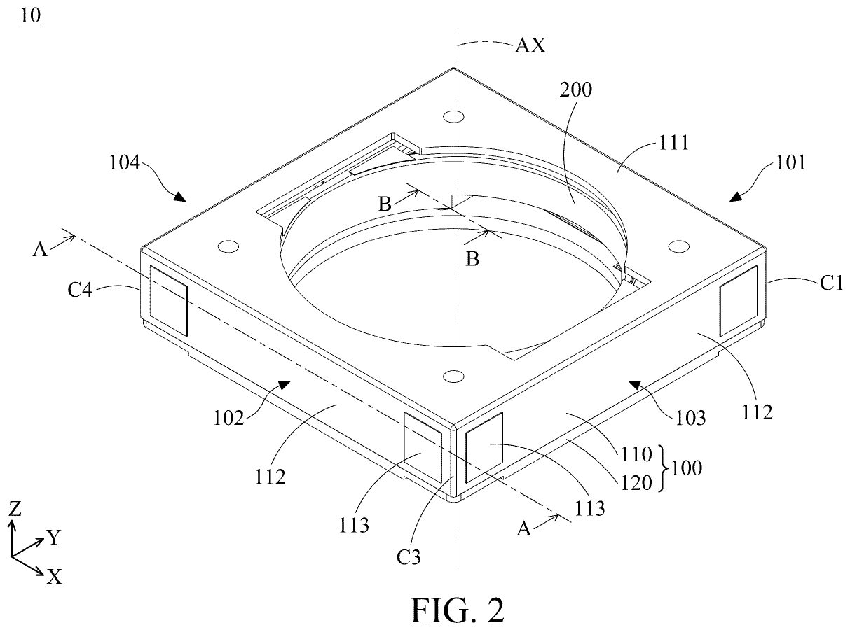

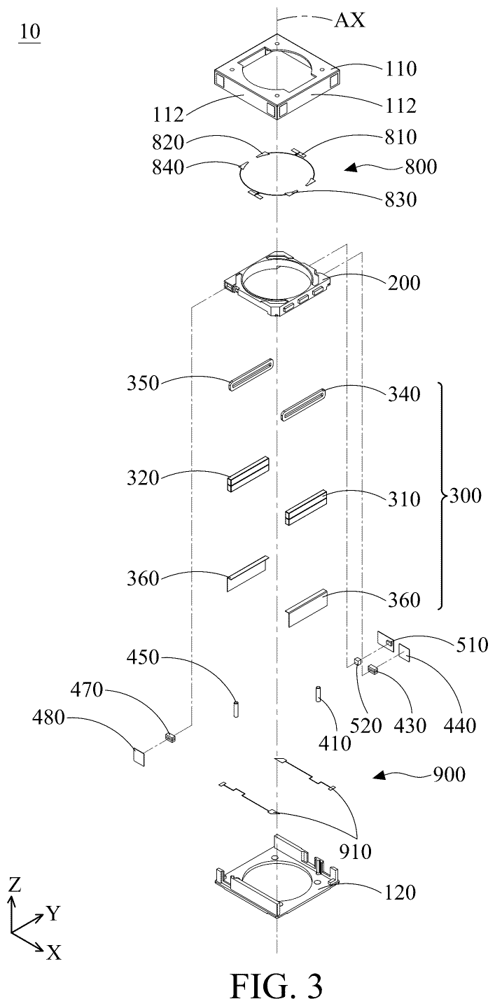

FIG. 2 is a schematic diagram of the optical member driving mechanism 10, and FIG. 3 is an exploded-view diagram of the optical member driving mechanism 10. As shown in FIG. 2 and FIG. 3, the optical member driving mechanism 10 primarily includes a fixed portion 100, a movable portion 200, and a driving assembly 300.

The fixed portion 100 includes a housing 110 and a base 120. The housing 110 and a base 120 can be engaged with each other to form a hollow box. The movable portion 200 and the driving assembly 300 can be accommodated in the hollow box. The housing 110 includes a top wall 111 and a plurality of lateral walls 112 connected to the top wall 111. One or more soft pads 113 are attached on the outer surface of each lateral wall 112, so as to prevent from the damage caused by the impact between the optical member driving mechanism 10 and the other members in the electronic device 20 when the electronic device 20 oscillates. When viewed along the main axis AX of the optical member driving mechanism 10 (i.e. the optical axis of the optical member 30, that is parallel to the Z-axis in the figures), the fixed portion 100 has a polygonal structure.

In this embodiment, when viewed along the main axis AX of the optical member driving mechanism 10, the fixed portion 100 has a rectangular structure including a first side 101, a second side 102, a third side 103, and a fourth side 104. The first side 101 is opposite the second side 102, the third side 103 and the fourth side 104 are situated between the first side 101 and the second side 102, and the third side 103 is opposite the fourth side 104. The junction of the first side 101 and the third side 103 forms a first corner C1, the junction of the first side 101 and the fourth side 101 forms a second corner C2, the junction of the second side 102 and the third side 103 forms a third corner C3, and the junction of the second side 102 and the fourth side 104 forms a fourth corner C4.

The movable portion 200 is configured to connect the optical member 30, and is movably connected to the fixed portion 100. In this embodiment, the movable portion 200 is movable relative to the fixed portion 100 along the main axis AX. In some embodiments, the movable portion is movable relative to the fixed portion 100 along a direction that is perpendicular to the main axis AX.

The driving assembly 300 can drive the movable portion 200 to move relative to the fixed portion 100. In detail, in this embodiment, the driving assembly 300 includes a first magnetic member 310, a second magnetic member 320, a first coil 340, and a second coil 350. The first magnetic member 310 and the second magnetic member 320 are affixed to the base 120 or the lateral walls 112 of the fixed portion 100, and respectively disposed on the third side 103 and the fourth side 104 of the fixed portion 100. The first coil 340 and the second coil 350 are disposed on the movable portion 200, and respectively correspond to the first magnetic member 310 and the second magnetic member 320.

When current flows through the first coil 340, an electromagnetic force can be generated between the first coil 340 and the first magnetic member 310 to push the movable portion 200 to move relative to the fixed portion 100 along the main axis AX. Similarly, when current flows through the second coil 350, an electromagnetic force can be generated between the second coil 350 and the second magnetic member 320 to push the movable portion 200 to move relative to the fixed portion 100 along the main axis AX. Therefore, the purpose of focusing, zooming, and/or optical image stabilization can be achieved.

In this embodiment, the driving assembly 300 further includes one or more permeability members 360. The permeability members 360 are embedded in the lateral walls 112 of the fixed portion 100, and enclose the surfaces of the first magnetic member 310 besides the surface facing the first coil 340 and the surfaces of the second magnetic member 320 besides the surface facing the second coil 350, so that the driving force of the driving assembly 300 can be enhanced.

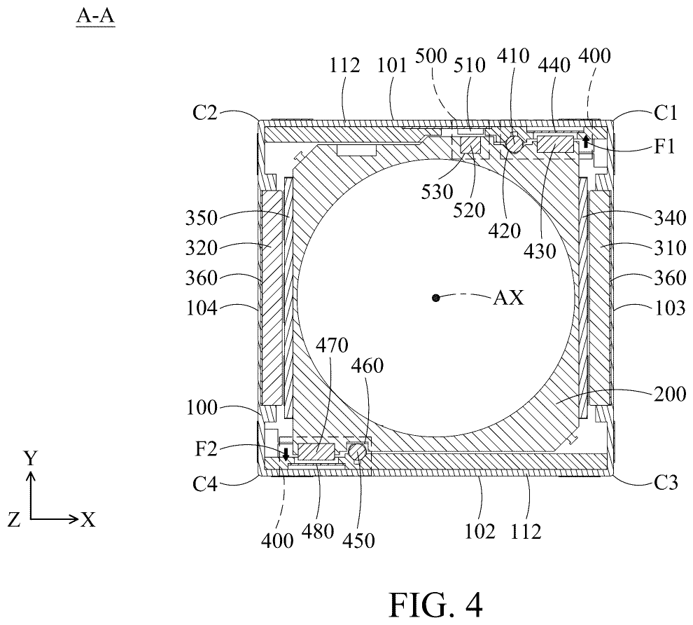

FIG. 4 is a cross-sectional view taken along the line A-A in FIG. 2. As shown in FIG. 2 to FIG. 4, in this embodiment, the optical member driving mechanism 10 includes a supporting assembly 400. The supporting assembly 400 includes a first intermediate member 410, a first corresponding member 420, a first forcing member 430, a first stabilizing member 440, a second intermediate member 450, a second corresponding member 460, a second forcing member 470, and a second stabilizing member 480.

The first intermediate member 410, the first corresponding member 420, the first forcing member 430, and the first stabilizing member 440 are disposed on the first side 101 of the fixed portion 100 and adjacent to the first corner C1 of the fixed portion 100. The first intermediate member 410 can be a cylinder affixed to the base 120, and the longitudinal axis of the cylinder is extended along a direction that is parallel to the main axis AX. The first corresponding member 420 is a recess formed on the surface of the movable portion 200 facing the lateral walls 112. The first intermediate member 410 can be accommodated in the first corresponding member 420 and movable relative to the first corresponding member 420.

The first forcing member 430 and the first stabilizing member 440 are respectively disposed on the movable portion 200 and the fixed portion 100. A first stabilizing force F1 can be formed therebetween and applied to the movable portion 200. For example, the first forcing member 430 can be a magnet, and the first stabilizing member 440 can include ferromagnetism material. Therefore, the magnetic attraction force between the first forcing member 430 and the first stabilizing member 440 can be used as the first stabilizing force F1. The movable portion 200 can lean against the first intermediate member 410 accordingly, and it can be ensured that the first intermediate member 410 is in contact with the first corresponding member 420.

In some embodiments, the first stabilizing member 440 can be a magnet, and the first forcing member 430 can include ferromagnetism material. In some embodiments, the first forcing member 430 and the first stabilizing member 440 are magnets attracting each other.

In this embodiment, when viewed from the main axis AX, the first stabilizing member 440 is closer to the first corner C1 than the first intermediate member 410. That is, the distance between the first stabilizing member 440 and the first corner C1 is less than the distance between the first intermediate member 410 and the first corner C1.

The second intermediate member 450, the second corresponding member 460, the second forcing member 470, and the second stabilizing member 480 are disposed on the second side 102 of the fixed portion 100 and adjacent to the fourth corner C4 of the fixed portion 100. The second intermediate member 450 can be a cylinder affixed to the base 120, and the longitudinal axis of the cylinder is extended along the direction that is parallel to the main axis AX. The second corresponding member 460 is a recess formed on the surface of the movable portion 200 facing the lateral walls 112. The second intermediate member 450 can be accommodated in the second corresponding member 460 and movable relative to the second corresponding member 460.

The second forcing member 470 and the second stabilizing member 480 are respectively disposed on the movable portion 200 and the fixed portion 100. A second stabilizing force F2 can be formed therebetween and applied to the movable portion 200. For example, the second forcing member 470 can be a magnet, and the second stabilizing member 480 can include ferromagnetism material. Therefore, the magnetic attraction force between the second forcing member 470 and the second stabilizing member 480 can be used as the second stabilizing force F2. The movable portion 200 can lean against the second intermediate member 450 accordingly, and it can be ensured that the second intermediate member 450 is in contact with the second corresponding member 460.

In some embodiments, the second stabilizing member 480 can be a magnet, and the second forcing member 470 can include ferromagnetism material. In some embodiments, the second forcing member 470 and the second stabilizing member 480 are magnets attracting each other.

In this embodiment, when viewed from the main axis AX, the second stabilizing member 480 is closer to the fourth corner C4 than the second intermediate member 450. That is, the distance between the second stabilizing member 480 and the fourth corner C4 is less than the distance between the second intermediate member 450 and the fourth corner C4.

Owing to the supporting assembly 400, when the driving assembly 300 drives the movable portion 200 to move relative to the fixed portion 100, the first intermediate member 410 and the second intermediate member 450 can guide the movable portion 200 to move along the main axis AX, so that the stability of movement of the movable portion can be increased.

Moreover, it should be noted that, when viewed along the main axis AX, the first corresponding member 420 and the second corresponding member 460 respectively has a V-shaped structure and U-shaped structure, so as to facilitated the assemble of the optical member driving mechanism 10.

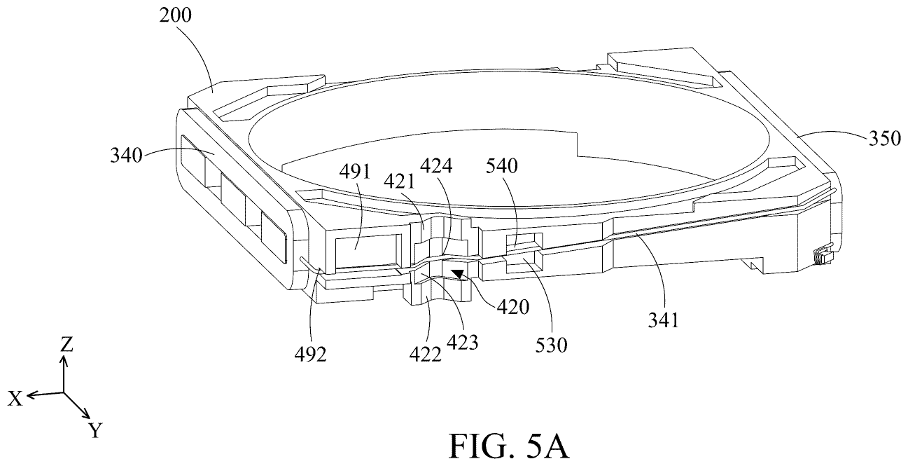

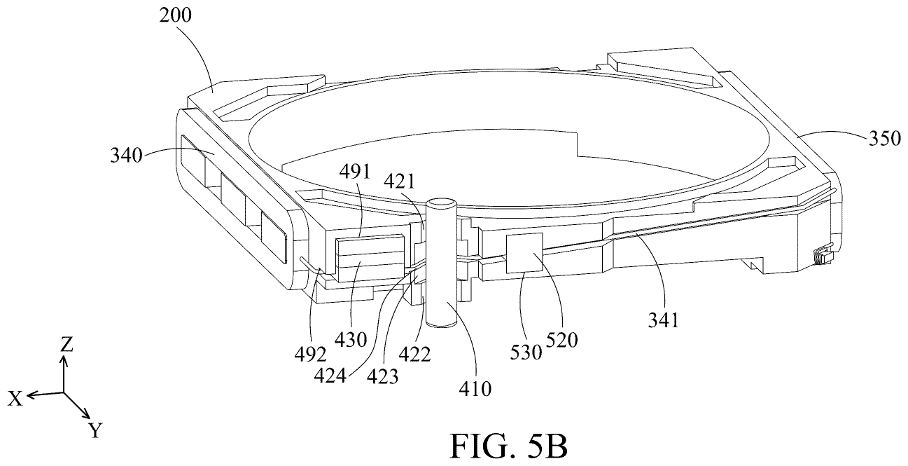

As shown in FIG. 5A and FIG. 5B, in this embodiment, the first corresponding member 420 includes a first corresponding part 421, a second corresponding part 422, a first depression part 423, and a first receiving part 424. The first depression part 423 is disposed between the first corresponding part 421 and the second corresponding part 422. The first receiving part 424 is formed in the first depression part 423, so that it is also disposed between the first corresponding part 421 and the second corresponding part 422. When the movable portion 200 is connected to the fixed portion via the supporting assembly 400, the first corresponding part 421 and the second corresponding part 422 are in contact with the first intermediate member 410, and the first depression part 423 is spaced away from the first intermediate member 410.

The first receiving part 424 has a depression structure or an opening structure. The lead 341 of the first coil 340 can be extended along the surface of the movable portion 200 facing the lateral walls, and can be received in the first receiving part 424. Therefore, when the first movable portion 200 moves along the first intermediate member 410, the lead 341 of the first coil 340 does not interfere with the first intermediate member 41, and the damage of the lead 341 of the first coil 340 can be prevented.

Similarly, the supporting assembly 400 can include a second depression part 491 and a second receiving part 492 formed on the movable portion 200. At least a portion of the first forcing member 430 is accommodated in the second depression part 491. The second receiving part 492 is formed in the second depression part 491 and has a depression structure or an opening structure. The lead 341 of the first coil 340 can be received in the second receiving part 492, so as to prevent the lead 341 of the first coil 340 from the damage.

Referring to FIG. 2 to FIG. 5B, in this embodiment, the optical member driving mechanism 10 includes a position sensing assembly 500. The position sensing assembly 500 includes a sensing member 510, a reference member 520, a third depression part 530, and a third receiving part 540.

The sensing member 510 can be connected to the fixed portion 100, and the reference member 520 can be disposed ono the movable portion 200. The sensing member 510 can detect the movement of the reference member 520 to notice the position of the movable portion 200 relative to the fixed portion 100. For example, the sensing member 510 can be a Hall sensor, a magnetoresistance effect sensor (MR sensor), a giant magnetoresistance effect sensor (GMR sensor), a tunneling magnetoresistance effect sensor (TMR sensor), or a fluxgate sensor, and the reference member 520 can be a magnet, but it is not limited thereto.

The third depression part 530 is formed on the movable portion 200, and at least a portion of the reference member 520 is accommodated in the third depression part 530. The third receiving part 540 is formed in the third depression part 530 and has a depression structure or an opening structure. The lead 340 of the first coil 340 can be received in the third receiving part 540, so as to prevent the lead 341 of the first coil 340 from the damage.

In this embodiment, the first intermediate member 410 is disposed between the position sensing assembly 500 and the first forcing member 430, and the first forcing member 430 is closer to the first corner C1 than the sensing assembly 500. In other words, the first receiving part 424 is disposed between the second receiving part 492 and the third receiving part 540, and the distance between the first forcing member 430 and the first corner C1 is less than the distance between the position sensing assembly 500 and the first corner C1.

In some embodiments, the positions of the sensing member 510 and the reference member 520 can be interchanged. That is, the sensing member 510 can be disposed on the movable portion 200, and the reference member 520 can be disposed on the fixed portion 100 correspondingly.

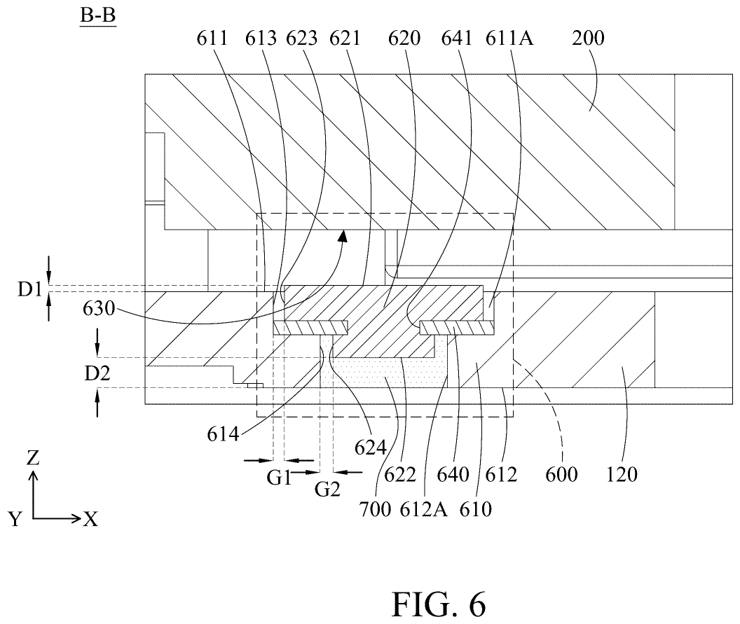

FIG. 6 is a cross-sectional view taken along the line B-B in FIG. 2. As shown in FIG. 2, FIG. 3, and FIG. 6, in this embodiment, the optical member driving mechanism 10 includes at least one stopping assembly 600 configured to restrict the moving range of the movable portion 200. In particular, the stopping assembly 600 includes a first body 610, a second body 620, a stopping portion 630, and a reinforcing portion 640.

The first body 610 can be a part of the base 120, and it can include plastic, but it is not limited thereto. The first body 610 includes a first surface 611 facing the movable portion 200 and a second surface 612 facing the opposite direction. A first depression 611A is formed on the first surface 611, a second depression 612A is formed on the second surface 612, and the first depression 611A and the second depression 612A are communicated with each other.

The second body 620 is accommodated in the first depression 611A and the second depression 612A, and protrudes from the first surface 611 of the first body 610. For example, the second body 620 can include soft material (such as rubber, silicone gel, or foam, but it is not limited thereto), so that its Young's modulus can be less than the Young's modulus of the first body 610.

The stopping portion 630 can be a part of the movable portion 200 corresponding to the second body 620. When the driving assembly 300 drives the movable portion 200 to move toward the base 120 to an extreme position, the stopping portion 630 can be in contact with the second body 620. Therefore, the stopping assembly 600 can restrict the moving range of the movable portion 200, and the impact between the movable portion 200 and the fixed portion 100 can be prevented.

The reinforcing portion 640 can be embedded in the base 120 and have a receiving portion 641. The position of the receiving portion 641 corresponds to the position of the first depression 611A and the position of the second depression 612A, so that at least a portion of the receiving portion 641 is exposed from the first depression 611A and the second depression 612A. The receiving portion 641 has an opening structure, and at least a portion of the second body 620 is disposed in the opening structure of the receiving portion 641. The reinforcing portion 640 includes metal, so that its Young's modulus can be greater than the Young's modulus of the first body 610 and the second body 620. Furthermore, at least a portion of the reinforcing portion 640 is embedded in the second body 620. Therefore, with the aforementioned arrangement, it is facilitated to position the second body 620, and the displacement of the second body 620 when the stopping portion 620 is in contact with the second body 620 can be prevented.

In this embodiment, the second body 620 has a third surface 620 and a fourth surface 622. The third surface 621 and the first surface 611 face the same direction, and the fourth surface 622 and the second surface 612 face the same direction. In a direction that is perpendicular to the first surface 611 (i.e. the direction parallel to the main body AX), the shortest distance D1 between the first surface 611 and the third surface 621 is less than the shortest distance D2 between the second surface 312 and the fourth surface 622.

Moreover, in this embodiment, the second body 620 is not in contact with the first body 610, and the gaps between the first body 610 and the second body 620 on the opposite sides of the reinforcing portion 640 are different. In detail, the first surface 610 has a fifth surface 613, and the second body 620 has a sixth surface 623. The fifth surface 613 and the sixth surface 623 face each other, and the sixth surface 623 is connected to the third surface 621 (that is, the fifth surface 613 and the sixth surface 623 are disposed above the reinforcing portion 640). A first gap G1 is formed between the fifth surface 613 and the sixth surface 623. The first body 610 further has a seventh surface 614, and the second body 620 further has an eighth surface 624. The seventh surface 614 and the eighth surface 624 face each other, and the eighth surface 624 is connected to the fourth surface 622 (that is, the seventh surface 614 and the eighth surface 624 are disposed below the reinforcing portion 640). A second gap G2 is formed between the seventh surface 614 and the eighth surface 624, and the second gap G2 is different from the first gap G1. For example, the second gap G2 is greater than the first gap G1.

In some embodiments, the reinforcing portion 640 can be electrically connected to the driving assembly 300 and/or the position sensing assembly 500, so as to facilitate the transmission of the current or the signal.

As shown in FIG. 6, in this embodiment, the optical member driving mechanism 10 can further include a connecting member 700. The connecting member 700 is disposed in the second depression 612A and in direct contact with the first body 610, the second body 620, and the reinforcing portion 640. For example, the connecting member 700 can be a non-conductive light-curing glue or a non-conductive thermal-curing glue. When the connecting member 700 is cured, it can be coplanar with the second surface 612. The defects in the optical member driving mechanism 10 caused by thermal expansion of the air in the second depression 612A during the assembly process can be therefore avoided.

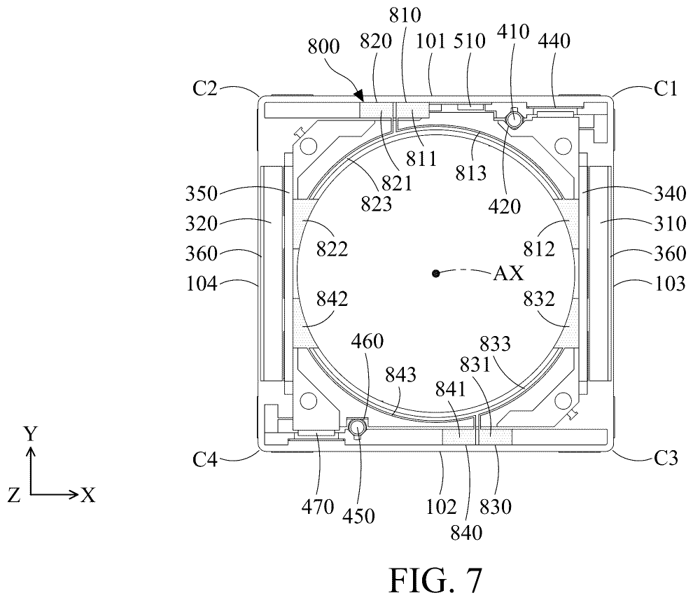

Referring to FIG. 2, FIG. 3, and FIG. 7, in this embodiment, the optical member driving mechanism 10 further includes an elastic assembly 800. The elastic assembly 800 is connected to the fixed portion 100 and the movable portion 200 to hang the movable portion 200 in the hollow box of the fixed portion 100, and is electrically connected to the driving assembly 300. The elastic assembly 800 can include a first elastic member 810, a second elastic member 820, a third elastic member 830, and a fourth elastic member 840.

The first elastic member 810 has a first fixed portion connecting end 811, a first movable portion connecting end 812, and a first string section 813. The first fixed portion connecting end 811 is affixed to the fixed portion 100 at the first side 101. The first movable portion connecting end 812 is adjacent to the third side 103 and affixed to the movable portion 200. The first string section 813 is disposed between the first fixed portion connecting end 811 and the first movable portion connecting end 812 and connects them. When viewed along the main axis AX, the first fixed portion connecting end 811 does not overlap the supporting assembly 400 and the position sensing assembly 500, and the first movable portion connecting end 812 does not overlap the driving assembly 300.

The second elastic member 820 has a second fixed portion connecting end 821, a second movable portion connecting end 822, and a second string section 823. The second fixed portion connecting end 821 is affixed to the fixed portion 100 at the first side 101. The second movable portion connecting end 822 is adjacent to the fourth side 104 and affixed to the movable portion 200. The second string section 823 is disposed between the second fixed portion connecting end 821 and the second movable portion connecting end 822 and connects them. When viewed along the main axis AX, the second fixed portion connecting end 821 does not overlap the supporting assembly 400 and the position sensing assembly 500, and the second movable portion connecting end 822 does not overlap the driving assembly 300.

The third elastic member 830 has a third fixed portion connecting end 831, a third movable portion connecting end 832, and a third string section 833. The third fixed portion connecting end 831 is affixed to the fixed portion 100 at the second side 102. The third movable portion connecting end 832 is adjacent to the third side 103 and affixed to the movable portion 200. The third string section 833 is disposed between the third fixed portion connecting end 831 and the third movable portion connecting end 832 and connects them. When viewed along the main axis AX, the third fixed portion connecting end 831 does not overlap the supporting assembly 400, and the third movable portion connecting end 832 does not overlap the driving assembly 300.

The fourth elastic member 840 has a fourth fixed portion connecting end 851, a fourth movable portion connecting end 842, and a fourth string section 843. The fourth fixed portion connecting end 841 is affixed to the fixed portion 100 at the second side 102. The fourth movable portion connecting end 842 is adjacent to the fourth side 104 and affixed to the movable portion 200. The fourth string section 843 is disposed between the fourth fixed portion connecting end 841 and the fourth movable portion connecting end 842 and connects them. When viewed along the main axis AX, the fourth fixed portion connecting end 841 does not overlap the supporting assembly 400, and the fourth movable portion connecting end 842 does not overlap the driving assembly 300.

It should be noted that, each of the first movable portion connecting end 812, the second movable portion connecting end 822, the third movable portion connecting end 832, and the fourth movable portion connecting end 842 is electrically connected to the first coil 340 and/or the second coil 350, and the first elastic member 810, the second elastic member 820, the third elastic member 830, and the fourth elastic member 840 are electrically independent of each other.

Moreover, in this embodiment, the length of the first string section 813 can be the same as the length of the fourth string section 843, the length of the second string section 823 can be the same as the length of the third string section 843, and the length of the first string section 813 can be the different the length of the second string section 823.

The elastic assembly 800 is connected to the movable portion and the fixed portion 100 at the upper side of the movable portion 200. Referring to FIG. 3, in this embodiment, the optical member driving mechanism 10 can further include an elastic assembly 900, and the elastic assembly 900 is connected to the movable portion 200 and the fixed portion 100 at the lower side of the movable portion 200.

The elastic assembly 900 can include two elastic members 910. The two elastic members 910 are connected to the movable portion 200 and the fixed portion 100 respectively at the first side 101 and the second side 102. Similarly, the elastic members 910 can be electrically connected to the driving assembly 300 and/or the reinforcing portion 640.

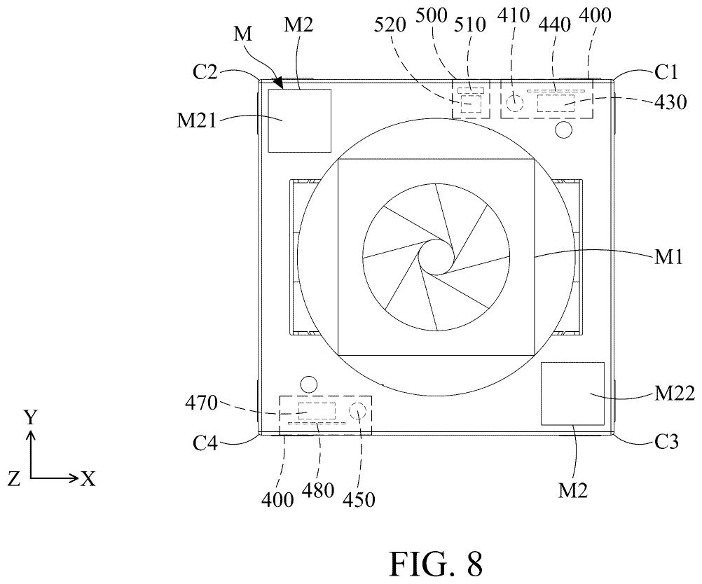

Referring to FIG. 8, in another embodiment of the invention, the optical member driving mechanism 10 can further include an optical module M disposed on the movable portion 200 and/or the fixed portion 100. The optical module M includes an optical unit M1 and at least one driving portion M2. For example, the optical unit M1 can be an aperture, a filter, a lens, or a sensor. The driving portion M2 can drive the optical unit M1 to move, rotate, and/or deform. In this embodiment, the driving portion M2 can include a first driving unit M21 and a second driving unit M22 respectively disposed on the first side 101 and the second side 102. When viewed along the main axis AX, the first driving unit M21 and the second driving unit M22 are respectively disposed at the second corner C2 and the third corner C3, the first driving unit M21 does not overlap the first forcing member 430, the first stabilizing member 440, and the position sensing assembly 500, and the second driving unit M22 does not overlap the second forcing member 470 and the second stabilizing member 480.

Each of the first driving unit M21 and the second driving unit M22 can be an electromagnetic motor or a piezoelectric motor, but it is not limited thereto.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

The optical member driving mechanism can further include a supporting assembly, and the movable portion moves relative to the fixed portion through the supporting assembly. The supporting assembly includes a first intermediate member, a first corresponding member, a first forcing member, and a first stabilizing member. The first corresponding member is in contact with the first intermediate member, and the first intermediate member and the first corresponding member are movable relative to each other. A first stabilizing force is applied to the movable portion by the first forcing member and the first stabilizing member. When viewed along the main axis, the fixed portion has a polygonal structure, and the first intermediate member is disposed on the first side of the fixed portion. When viewed along the main axis, the first intermediate member is adjacent to the first corner of the fixed portion, and the distance between the first stabilizing member and the first corner is less than the distance between the first intermediate member and the first corner.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move.

2. The optical member driving mechanism as claimed in claim 1, wherein the optical member driving mechanism further comprises a supporting assembly, the movable portion moves relative to the fixed portion through the supporting assembly, and the supporting assembly comprises:
a first intermediate member;
a first corresponding member, contacting the first intermediate member, wherein the first intermediate member and the first corresponding member are movable relative to each other;
a first forcing member; and
a first stabilizing member, wherein a first stabilizing force is applied to the movable portion by the first forcing member and the first stabilizing member,
wherein when viewed along a main axis, the fixed portion has a polygonal structure, and the first intermediate member is disposed on a first side of the fixed portion,
wherein when viewed along the main axis, the first intermediate member is adjacent to a first corner of the fixed portion, and a distance between the first stabilizing member and the first corner is less than a distance between the first intermediate member and the first corner.

3. The optical member driving mechanism as claimed in claim 2, wherein the optical member driving assembly further comprises a position sensing assembly configured to detect a movement of the movable portion, wherein when viewed along the main axis, the position sensing assembly is disposed on the first side, the first intermediate member is disposed between the position sensing assembly and the first forcing member, and a distance between the first forcing member and the first corner is less than a distance between the position sensing assembly and the first corner.

4. The optical member driving mechanism as claimed in claim 3, wherein the first corresponding member comprises:
a first corresponding part, in direct contact with the first intermediate member;
a second corresponding part, in direct contact with the first intermediate member;
a first depression part, formed between the first corresponding part and the second corresponding part; and
a first receiving part, configured to receive a lead of the driving assembly, wherein the first receiving part has a depression structure or an opening structure, and the first receiving part is formed in the first depression part,
wherein the first depression part is disposed between the first corresponding part and the second corresponding part.

5. The optical member driving mechanism as claimed in claim 4, wherein the supporting assembly further comprises a second depression part and a second receiving part, the second depression part is configured to receive at least a portion of the first forcing member or at least a portion of the first stabilizing member, and the second receiving part is formed in the second depression part and configured to receive the lead of the driving assembly.

6. The optical member driving mechanism as claimed in claim 5, wherein the position sensing assembly comprises:
a reference member;
a sensing member, detecting a position of the reference member;
a third depression part, configured to receive at least a portion of the sensing member or at least a portion of the reference member; and
a third receiving part, formed in the third depression part and configured to receive the lead of the driving assembly, wherein when viewed along the main axis, the first receiving part is disposed between the second receiving part and the third receiving part.

7. The optical member driving mechanism as claimed in claim 4, wherein the first depression part is spaced away from the first intermediate member.

8. The optical member driving mechanism as claimed in claim 3, wherein the optical member driving mechanism further comprises an optical module disposed on the movable portion, and the optical module comprises:
an optical unit; and
a driving portion, configured to drive the optical unit to move, wherein when viewed along the main axis, the driving portion does not overlap the supporting assembly and the position sensing assembly.

9. The optical member driving mechanism as claimed in claim 2, wherein the optical member driving mechanism further comprises an optical module disposed on the movable portion, and the optical module comprises an optical unit and a driving portion, and the driving portion drives the optical unit to move by electromagnetic force, wherein:
when viewed along the main axis, the driving portion does not overlap the first forcing member,
when viewed along the main axis, the driving portion does not overlap the first stabilizing member,
when viewed along the main axis, a first driving unit of the driving portion is disposed on the first side, and the first driving unit is disposed on a second corner of the fixed portion.

10. The optical member driving mechanism as claimed in claim 2, wherein the supporting assembly further comprises a second intermediate member and a second corresponding member, the second corresponding member is in contact with the second intermediate member, and the second intermediate member and the second corresponding member are movable relative each other.

11. The optical member driving mechanism as claimed in claim 10, wherein the fixed portion further comprises a second side, a third side, and a fourth side, the second side is opposite the first side, the third side and the fourth side are disposed between the first side and the second side, and the third side is opposite the fourth side,
wherein a junction of the first side and the third side forms the first corner, a junction of the first side and the fourth side forms a second corner, a junction of the second side and the third side forms a third corner, and a junction of the second side and the fourth side forms a fourth corner,
wherein the second intermediate member is disposed on the second side and adjacent to the fourth corner.

12. The optical member driving mechanism as claimed in claim 10, wherein the first corresponding member has a V-shaped structure, and the second corresponding member has a U-shaped structure.

13. The optical member driving mechanism as claimed in claim 2, wherein the optical member driving mechanism further comprises a stopping assembly configured to restrict a moving range of the movable portion, and the stopping assembly comprises:
a stopping portion;
a first body, wherein the first body is movable relative to the stopping portion;
a reinforcing portion, disposed on the first body and having a receiving portion, wherein the receiving portion has an opening structure; and
a second body, wherein at least a portion of the second body is disposed in the opening structure of the receiving portion, wherein:
when the movable portion is in an extreme position, the stopping portion is in contact with the second body,
a Young's modulus of the reinforcing portion is different from a Young's modulus of the first body,
the Young's modulus of the reinforcing portion is different from a Young's modulus of the second body, and
the Young's modulus of the first body is different from the Young's modulus of the second body.

14. The optical member driving mechanism as claimed in claim 13, wherein the Young's modulus of the reinforcing portion is greater than the Young's modulus of the first body, the Young's modulus of the reinforcing portion is greater than the Young's modulus of the second body, and the Young's modulus of the first body is greater than the Young's modulus of the second body.

15. The optical member driving mechanism as claimed in claim 13, wherein at least a portion of the reinforcing portion is embedded in the first body, and at least a portion of the reinforcing portion is embedded in the second body.

16. The optical member driving mechanism as claimed in claim 13, wherein the first body has a first surface and a second surface, and the first surface and the second surface face different directions,
the first surface has a first depression, and at least a portion of the receiving portion is exposed from the first depression,
the second surface has a second depression, and at least a portion of the receiving portion is exposed from the second depression.

17. The optical member driving mechanism as claimed in claim 16, wherein the second body has a third surface and a fourth surface, the third surface and the first surface face the same direction, and the fourth surface and the second surface face the same direction,
in a direction that is perpendicular to the first surface, a shortest distance between the first surface and the third surface is different from a shortest distance between the second surface and the fourth surface,
in a direction that is perpendicular to the first surface, a shortest distance between the first surface and the third surface is less than a shortest distance between the second surface and the fourth surface,
the third surface is not accommodated in the first depression.

18. The optical member driving mechanism as claimed in claim 16, wherein the first body further has a fifth surface, the second body further has a sixth surface, the fifth surface faces the second body, the sixth surface faces the first body, and a first gap is formed between the fifth surface and the sixth surface,
the first body further has a seventh surface, the second body further has an eighth surface, the seventh surface faces the second body, the eighth surface faces the first body, a second gap is formed between the seventh surface and the eighth surface, and the first gap is different from the second gap,
the reinforcing portion is disposed between the fifth surface and the seventh surface, and the reinforcing portion is disposed between the sixth surface and the eighth surface, and
the first surface faces the movable portion.

19. The optical member driving mechanism as claimed in claim 16, wherein the optical member driving mechanism further comprises a connecting member disposed in the second depression, and the connecting member is in direct contact with the first body, the second body, and the reinforcing portion.

20. The optical member driving mechanism as claimed in claim 2, wherein the fixed portion further comprises a second side, a third side, and a fourth side, the second side is opposite the first side, the third side and the fourth side are disposed between the first side and the second side, and the third side is opposite the fourth side, wherein the optical member driving mechanism further comprises an elastic assembly, and the elastic assembly comprises:
a first elastic member, having a first fixed portion connecting end, a first movable portion connecting end, and a first string section, the first fixed portion connecting end is connected to the fixed portion at the first side, the first movable portion connecting end is connected to the movable portion and adjacent to the third side, and the first string section is connected to the first fixed portion connecting end and the first movable portion connecting end;
a second elastic member, having a second fixed portion connecting end, a second movable portion connecting end, and a second string section, the second fixed portion connecting end is connected to the fixed portion at the first side, the second movable portion connecting end is connected to the movable portion and adjacent to the fourth side, and the second string section is connected to the second fixed portion connecting end and the second movable portion connecting end;
a third elastic member, having a third fixed portion connecting end, a third movable portion connecting end, and a third string section, the third fixed portion connecting end is connected to the fixed portion at the second side, the third movable portion connecting end is connected to the movable portion and adjacent to the third side, and the third string section is connected to the third fixed portion connecting end and the third movable portion connecting end; and
a fourth elastic member, having a fourth fixed portion connecting end, a fourth movable portion connecting end, and a fourth string section, the fourth fixed portion connecting end is connected to the fixed portion at the second side, the fourth movable portion connecting end is connected to the movable portion and adjacent to the fourth side, and the fourth string section is connected to the fourth fixed portion connecting end and the fourth movable portion connecting end, wherein:
the first movable portion connecting end, the second movable portion connecting end, the third movable portion connecting end, and the fourth movable portion connecting end are electrically connected to the driving assembly, and the first elastic member, the second elastic member, the third elastic member, and the fourth elastic member are electrically independent,
a length of the first string is different from a length of the second string, the length of the first string is different from a length of the third string, and the length of the third string is different from a length of the fourth string.
